(19) United States
(12) Patent Application Publication
(10) Pub. No.: US 2009/0006187 A1
(43) Pub. Date: Jan. 1, 2009

(54) Profile based advertising method for out-of-line advertising delivery

(76) Inventor: Andrew Marcuvitz, Lincoln, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/221,162

(22) Filed: Jul. 31, 2008

Related U.S. Application Data
(63) Continuation-in-part of application No. 11/823,863, filed on Jun. 28, 2007.

(51) Int. Cl. G06Q 30/00

(52) U.S. Cl. 705/10; 705/14

(57) ABSTRACT

A system and method of delivering and accessing information including advertisements targeted to a user that assures the privacy protection of the user, and allows the user to access the advertisements without interrupting the flow of desired information content. The system includes at least one computerized user device and at least one ad matching entity communicably coupled to at least one network. The ad matching entity includes a master computer system and at least one computer sub-system, in which each sub-system is associated with a respective user device. The user device creates a user profile based upon data obtained from observing various user actions, including the consumption/abandonment of content programs or advertisements, the visiting of web pages, the use of web search terms, etc. The user profile data is provided by the user device to the sub-system of the ad matching entity, which is a trusted third party. The ad matching sub-system locally matches information contained in the user profile against information contained in a target profile, and sends the results to the master system. Based on these results, the master system transmits at least one advertisement targeted to the user to the user device. The ad matching entity then permanently deletes all records and copies of the user profile from its data storage. At a later time chosen by the user, the user can consume the advertisement in an out-of-line fashion independently of the consumption of any desired information content.

### CROSS REFERENCE TO RELATED APPLICATIONS

This application is a continuation-in-part application of prior U.S. patent application Ser. No. 11/823,863 filed Jun. 28, 2007 entitled A PROFILE BASED ADVERTISING METHOD FOR OUT-OF-LINE ADVERTISING DELIVERY.

### STATEMENT REGARDING FEDERALLY SPONSORED RESEARCH OR DEVELOPMENT

Not applicable

### BACKGROUND OF THE INVENTION

The present invention relates generally to systems and methods of delivering and accessing information targeted to a user, and more specifically to a system and method of delivering and accessing information including advertisements targeted to a user that assures the privacy protection of the user, allows the user to access the advertisements without interrupting the flow of desired information content, monitors the user's interaction with the delivered information to provide advertisers and information content owners with performance-based feedback relating to their services, and enables the user to control the degree to which payment for the delivered information is user-supported or advertiser-supported.

Systems and methods of delivering information such as advertisements targeted to a user are known that can be employed to electronically deliver advertisements, based upon a profile of the user, over a communications network such as the Internet. For example, some conventional systems and methods of delivering advertisements targeted to a user are configured to gather data for a user's profile by monitoring the user's activity as he or she navigates the Internet and browses various web sites, and by storing, in a memory, at least some information pertaining to each site visited by the user. While the user continues navigating the Internet and browsing web sites, this information pertaining to each visited site is extracted from storage to create the user's profile. For example, the extracted information can be parsed, and various headings and/or words can be identified and stored as keywords in a database. In addition, the time that the user spent at each visited site, and the time spent within particular sections of the site, can be logged. Some conventional systems gather data for a user's profile over time in an unobtrusive manner, without soliciting any information from the user. Other conventional systems allow the user to explicitly submit information relating to certain user attributes such as the location where he or she lives, and/or his or her age group, educational background, profession, income level, marital status, hobbies and interests, etc. Further, weights can be assigned to selected user attributes based upon, e.g., the types of web sites visited by the user, and/or the length of time spent at each site, thereby providing an indication of the level of the user's interest with regard to a respective attribute. Once a detailed profile of the user is created, a determination can be made as to whether or not the user's profile matches a target profile of a particular advertiser. If the user's profile matches the target profile of an advertiser, then targeted advertisements (the “ad content”) can be delivered to that user.

Such targeted ad content is typically delivered to the user in an “in-line” fashion, for example, by displaying the ad content on a web page currently being viewed by the user. Such ad content targeted to a specific user or user group, and dynamically displayed on a web page containing information content relevant to the ad content, is known as a contextual advertisement. If the user's profile fails to match an advertiser's target profile, then generic ad content can optionally be delivered to that user. In response to the delivery of targeted ad content that directly appeals to the background and interests of the system user, advertisers can often realize increased sales of their products and services.

However, such conventional systems and methods of delivering information targeted to a user have drawbacks. For example, not only may the concept of gathering data for creating a user's profile be objectionable to some users, but the process of gathering such data may violate the privacy rights of the user, particularly when such data gathering is performed by the system without the user's knowledge or consent. Even if profile data were voluntarily submitted by the user, the user's privacy rights might still be violated if the entity gathering the data purposefully or inadvertently discloses it to one or more third parties. Such privacy concerns may cause some users to be reluctant to disclose any private or personal information over a public network, and, as a result, may curtail the widespread adoption of electronically delivered, targeted ad content.

In addition, the delivery of targeted ad content over the Internet in an in-line fashion can be a source of frustration for some users, especially when the delivery of such ad content interrupts the flow of desired information content. The frustration of such users is often exacerbated when targeted ad content is delivered in-line to the user while he or she is casually surfing the web. In addition, as the use of the Internet expands to include the delivery of audio and/or video media, and as broadcast media is increasingly viewed by users with time-shifting content viewer devices such as personal computers (PCs) and personal video recorders (PVRs), it is becoming increasing difficult to assure that contextual advertisements are delivered to the user in association with relevant information content. This is because such content viewer devices typically allow users to skip over sections of audio and/or video as the content is consumed. Such difficulty in associating contextual advertisements with relevant information content may threaten the future viability of advertising supported media using traditional in-line delivery techniques.

It would therefore be desirable to have an improved system and method of delivering and accessing information including advertisements targeted to a user that avoids the drawbacks of the above-described conventional systems and methods.

### BRIEF SUMMARY OF THE INVENTION

In accordance with the present invention, a system and method of delivering and accessing information including advertisements targeted to a user (herein referred to as the “audience member”) is disclosed that assures the privacy protection of the audience member, allows the audience member to access the advertisements without interrupting the flow of desired information content, monitors the audience member's interaction with the advertisements to provide advertisers with performance-based feedback relating to their advertising services, and enables the audience member to control the degree to which payment for the delivered information is member-supported or advertiser-supported.

In one embodiment, the presently disclosed system for delivering and accessing information including advertisements targeted to a user (the “audience member”) includes at least one communications network, at least one computerized member device, at least one advertisement matching entity (the “ad matching entity”), and a settlement system. The computerized member device, the ad matching entity, and the settlement system are each communicably coupled to the communications network, which may include a wireless or wired private network such as a local area network (LAN) or a wide area network (WAN), a wireless or wired public network such as the Internet, a cable television (CATV) distribution network, a wide area telephone or data network, and/or any other suitable network. Each computerized member device includes at least one content storage component, and at least one content viewer component. In addition, each computerized member device includes a member profile manager component operative to create and maintain at least one audience member profile containing data that can subsequently be used by the ad matching entity to target advertisements relevant to the background and interests of the audience member. For example, each computerized member device can be implemented as a personal computer (PC), a television-connected set top box (TV-STB), a personal video recorder (PVR), a Smartphone, a personal digital assistant (PDA), a home gateway device, a media extender, or any other suitable computerized device. It should be noted that in the context of the present invention, the delivered information can include not only targeted advertisements (the “ad content”), but also information content (e.g., a song or a movie) directly offered to the audience member by an information content owner. In this case, the information content owner and the advertiser would be one and the same.

The computerized member device is also operative to provide performance-based feedback to the ad matching entity relating to observable events such as whether the targeted information including ad content and/or desired information content was consumed (i.e., viewed and/or listened to) by the audience member completely or partially, the number of times the targeted information was consumed by the audience member, whether or not the audience member acted in response to the consumption of the targeted information, whether or not the targeted information was saved by the audience member, the order in which the ad content and the desired information content were consumed, etc.

In the presently disclosed embodiment, the ad matching entity is a trusted third party operative to match advertisements (the “ad content”) provided by one or more advertisers with the audience member based at least in part upon the data contained in the audience member profile. It should be noted that none of the actual data contained in the audience member profile is disclosed to any other entity other than the ad matching entity, i.e., the trusted third party. It is further noted that the ad content and the desired information content may comprise text, image, audio, and/or video media, and therefore the ad content and information content may be consumed by the audience member by viewing and/or listening to the respective content using the computerized member device, which may include, e.g., at least one memory and/or any other suitable data storage device, a video processor and display, an audio processor, and at least one speaker.

The settlement system is operative to monitor the monetary amounts to be paid, by the audience member, to the owners of the information content for the cost of the content consumed by that audience member, and to monitor the monetary amounts to be paid, by the advertisers, to the audience member for the value of the advertisements consumed by that audience member, based at least in part upon the consumption behavior of the audience member. In the disclosed embodiment, the settlement system is configured to implement all of the monetary settlements within the system, including debiting and/or charging or crediting, as appropriate, suitable monetary amounts or their equivalents from/to accounts associated with the audience member, the content owners, and the advertisers, in accordance with instructions provided by the ad matching entity i.e., the trusted third party.

In the presently disclosed embodiment, each of the ad matching entity and the settlement system can be embodied as a single computer system or as multiple computer systems. In one embodiment, each of the ad matching entity and the settlement system is embodied as a master computer system and a plurality of computer sub-systems, in which each computer sub-system is included in or otherwise associated with a separate computerized user device. The master computer system corresponding to each of the ad matching entity and the settlement system can also be embodied as a single computer system or as multiple computer systems. In this way, at least a portion of the functionality of the ad matching entity and/or the settlement system can be distributed among and locally performed at multiple computerized user devices.

In one embodiment, a system for consuming targeted content such as advertisements and/or desired information content using a distributed ad matching technique includes at least one network, a plurality of computerized user devices communicably coupled to the network, and at least one computerized trusted device communicably coupled to the network. Each of the user devices includes a user profile manager component, and is operative to perform, in response to audience member interaction with the respective user device, at least one specified action. The computerized trusted device can include a master computer system and a plurality of separate computer sub-systems, in which each of the separate sub-systems is associated with one of the user devices. The user profile manager component within each of the user devices is operative to generate, in response to the specified action performed by the respective user device, data corresponding to the specified action, and to generate a user profile containing at least some of the generated data. In addition, each of the separate sub-systems of the computerized trusted device is operative to match content with the audience member based at least in part upon the data contained in the user profile, which was generated by the user profile manager component within the user device associated with the respective sub-system. The master system of the computerized trusted device can then transmit, over the network, the matched content to the user device associated with the respective sub-system.

In another embodiment, a system for consuming targeted content such as advertisements and/or desired information content using a distributed account settlement technique includes at least one network, a plurality of computerized user devices communicably coupled to the network, at least one computerized trusted device communicably coupled to the network, and at least one settlement system communicably coupled to the network. Each of the user devices includes a content viewer component. The computerized trusted device includes a plurality of separate sub-systems, in which each of the separate sub-systems of the computerized trusted device is associated with one of the user devices. The settlement system also includes a plurality of separate sub-systems, in which each of the separate sub-systems of the settlement system is associated with one of the user devices. The content viewer component within each of the user devices is operative to allow the audience member to consume the information content and the advertisement content. Each of the user devices is operative to generate, responsive to at least one specified action performed by the audience member while consuming the information content and/or the advertisement content, data corresponding to the specified action, and to generate performance-based feedback containing at least some of the generated data. Each of the separate sub-systems of the computerized trusted device is operative to generate, based at least in part upon the performance-based feedback generated by the user device associated with the respective sub-system, at least one instruction for implementing at least one monetary settlement for the consumption of the information content and/or the advertisement content by the audience member, and to provide the instruction to the sub-system of the settlement system associated with the user device that generated the performance-based feedback. The sub-system of the settlement system associated with the user device that generated the performance-based feedback can then implement the monetary settlement base upon that instruction.

By creating and maintaining private or personal audience member profile data locally on one or more computerized member devices associated with the audience member, giving the audience member full visibility and control over the audience member profile, allowing the audience member to voluntarily disclose the audience member profile data outside of the computerized member devices when he or she wishes to receive targeted content, and securely transmitting the audience member profile data to an ad matching entity that is also a trusted third party for temporary storage by the trusted third party while the targeted content is being delivered to the audience member, the privacy protection of the audience member can be assured. Further, by enabling targeted ad content to be consumed in an out-of-line fashion independently of the consumption of desired information content, the audience member can avoid frustrating interruptions of the flow of the information content. Moreover, by keeping track of how the targeted ad content and the desired information content was consumed by the audience member, both advertisers and information content owners can be provided with performance-based feedback relating to their services. In addition, by allowing at least some of the ad matching and account settlement functions to be performed locally in a distributed fashion by multiple sub-systems associated with the respective computerized member devices, the privacy protection of the audience member can be enhanced, while making more efficient use of the processing capacity of the respective member devices.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1a is a block diagram of a system for electronically delivering information including advertisements targeted to a user according to the present invention;

FIG. 1b is a block diagram of a computerized user device included in the system of FIG. 1a;

FIG. 2 is a flow diagram of a method of consuming targeted advertisements using the system of FIG. 1a;

FIG. 3 is a flow diagram of a method of consuming desired information content using the system of FIG. 1a;

FIG. 4 is a block diagram of an alternative embodiment of the system of FIG. 1a, in which at least a portion of the functionality of an ad matching entity and an account settlement system is distributed among multiple computerized user devices; and

FIGS. 5a-5c depict a flow diagram of a method of consuming targeted advertisements or desired information content using the system of FIG. 4.

### DETAILED DESCRIPTION OF THE INVENTION

U.S. patent application Ser. No. 11/823,863 filed Jun. 28, 2007 entitled A PROFILE BASED ADVERTISING METHOD FOR OUT-OF-LINE ADVERTISING DELIVERY is hereby incorporated herein by reference in its entirety.

A system and method of delivering and accessing information including advertisements targeted to a user (herein referred to as the “audience member”) is provided that assures the privacy protection of the audience member, allows the audience member to access the advertisements without interrupting the flow of desired information content, monitors the audience member's interaction with the advertisements and desired information content to provide advertisers and information content owners with performance-based feedback relating to their services, and enables the audience member to control the degree to which payment for the delivered information is member-supported or advertiser-supported. The presently disclosed system and method can be employed to effectively separate the delivery of advertisements from the delivery of desired information content to the audience member, while maintaining contextual information that forms the basis for targeting advertisements relevant to the background and interests of that audience member.

In one embodiment, the disclosed system includes a plurality of computerized member devices communicably coupled to at least one communications network. Each computerized member device is operative to connect to the communications network, to interact with the audience member, and to store content including various types of media such as text, image, audio, and/or video. Each computerized member device includes a member profile manager component operative to create an audience member profile based upon observable member behavior and/or explicit member specification. Via the computerized member device, the audience member profile is completely visible to, editable by, and solely controlled by the audience member. Under the control of the audience member, the computerized member device transmits the audience member profile over a secure network connection to an advertisement matching entity (the “ad matching entity”), which is a trusted third party. The ad matching entity is operative to temporarily store the audience member profile, to target advertisements to the audience member based upon the stored profile data, and to deliver, over the network, the targeted advertisement to the computerized member device for subsequent consumption (i.e., viewing and/or listening) by the audience member. After the targeted advertisement is delivered to the audience member, the ad matching entity discards all of its records and copies of the audience member profile. The computerized member component also includes a content storage component operative to store the targeted advertisement and any desired information content, and a content viewer component operative to allow the audience member to elect to consume (i.e., to view and/or listen to) the targeted advertisement in an out-of-line fashion independently of the consumption of the desired information content.

For example, the targeted advertisement (the “ad content”) and any other information content stored in the content storage component can include text, image, audio, and/or video media. Further, the computerized member device can include at least one memory and/or any other suitable data storage device, a video processor, a video display, an audio processor, and at least one speaker operative in conjunction with the content viewer component to allow the audience member to view and/or listen to the ad content and other information content. The computerized member component is also operative to provide, to the ad matching entity and/or an information content owner, performance-based feedback relating to how the targeted advertisement and/or the information content was consumed by the audience member, thereby enabling the ad matching entity and/or the information content owner to obtain a measure of the performance of the targeted advertisement and/or the information content, and to adjust their operating procedures accordingly, based at least in part upon the observed behavior of the audience member. The computerized member device can also provide this performance-based feedback to the ad matching entity for use in generating instructions for the settlement system with regard to monetary amounts to be credited or charged to, or debited from, the audience member's account, and monetary amounts to be paid by the audience member and/or the advertiser to the information content owner, for the cost or value of the delivered information content.

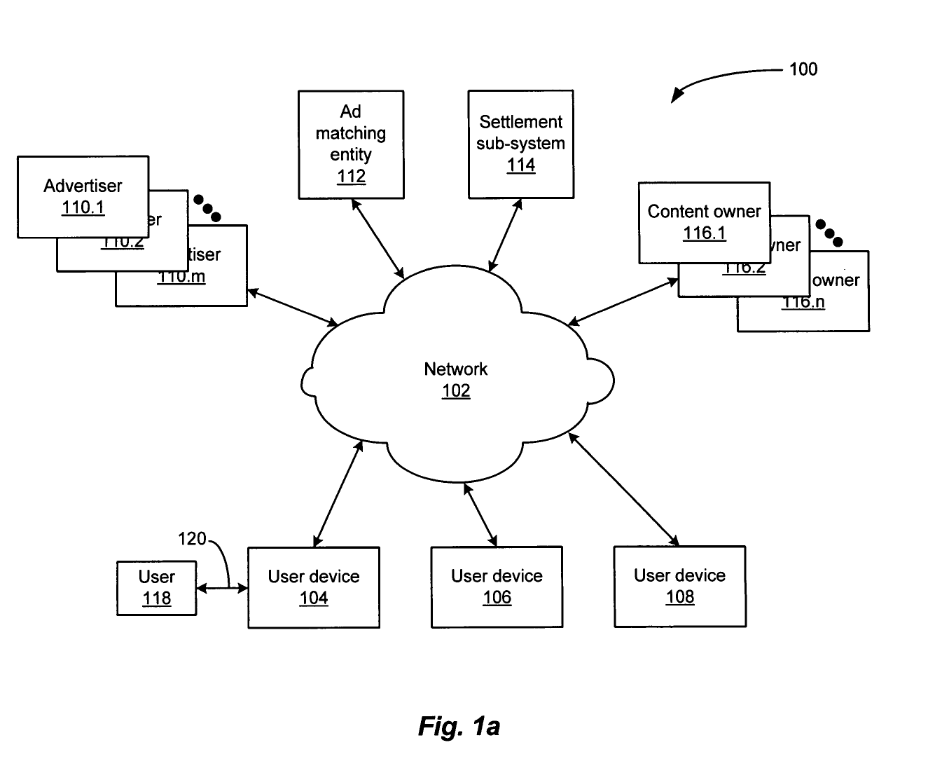

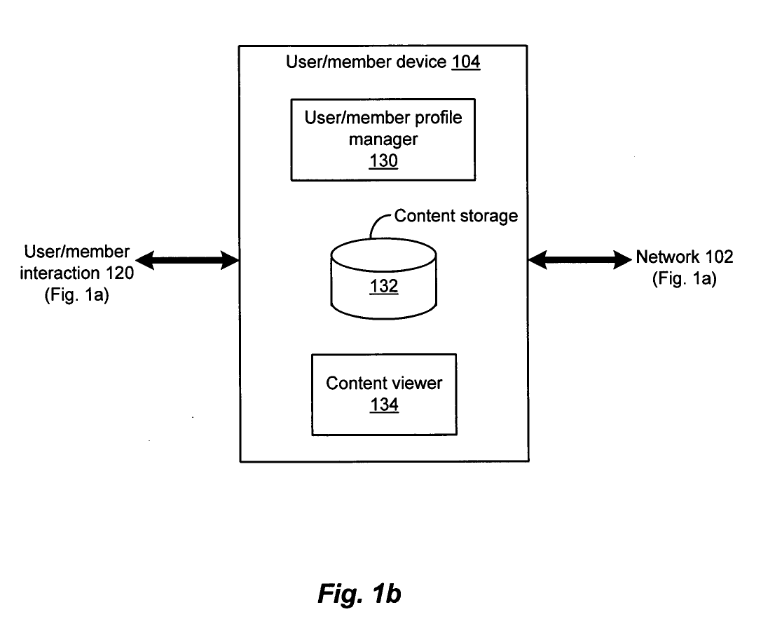

FIG. 1a depicts an illustrative embodiment of a system 100 for electronically delivering and accessing information including advertisements targeted to a user (the “audience member”), in accordance with the present invention. In the illustrated embodiment, the system 100 includes a communications network 100, a plurality of computerized member devices 104, 106, 108, an advertisement matching entity 112 (the “ad matching entity”), and a settlement system 114. Each of the computerized member devices 104, 106, 108, the ad matching entity 112, and the settlement system 114 is communicably coupled to the communications network 102. For example, the network 102 can include a wireless or wired private network such as a local area network (LAN) or a wide area network (WAN), a wireless or wired public network such as the Internet, a cable television (CATV) distribution network, a wide area telephone or data network, or any other suitable network. Further, each computerized member device can be implemented as a personal computer (PC), a television-connected set top box (TV-STB), a personal video recorder (PVR), a Smartphone, a personal digital assistant (PDA), a home gateway device, a media extender, or any other suitable computerized device.

FIG. 1b depicts a number of functional components included in the computerized member device 104 of FIG. 1a. It is understood that each of the other computerized member devices 106, 108 can include one or more of the same functional components as the computerized member device 104. Specifically, the computerized member device 104 includes a member profile manager component 130, a content storage component 132, and a content viewer component 134. The member profile manager component 130 is operative to create and maintain locally at least one audience member profile, which contains data that can be subsequently used by the ad matching entity 112 to target advertisements (the “ad content”) relevant to the background and interests of an audience member 118. The content storage component 132 is operative to store the ad content targeted to the audience member 118, and any other information content desired by the audience member 118. The content viewer component 134 is operative to facilitate the audience member's consumption (i.e., viewing and/or listening) of the targeted ad content and the desired information content. As shown in FIG. 1b, the computerized member device 104 is advantageously positioned in a content stream between the audience member 118 and the network 102, thereby allowing the device 104 to observe all of the interactions 120 of the audience member 118 with the various entities connected to the network 102.

In the presently disclosed embodiment, the ad matching entity 112 is a trusted third party operative to match ad content provided by one or more advertisers 110.1-110.m with the audience member 118, based at least in part upon the data contained in the audience member profile. For example, the ad matching entity 112 can be a single trusted business entity, a trusted federation of business entities, or any other suitable trusted entity or grouping of entities. Further, the computerized member device 104 is operative to provide, to the ad matching entity 112, performance-based feedback based upon how the audience member 118 interacts with the stored ad content and any desired information content. It should be understood, however, that none of the sensitive data contained in the audience member profile or the observed performance-based feedback is provided to the settlement system 114, or any other entity other than the ad matching entity 112, i.e., the trusted third party. Based upon instructions generated and provided by the ad matching entity 112, the settlement system 114 monitors the monetary amounts to be paid, by the audience member 118, to the information content owners 116.1-116.n for the cost or value of the information content consumed by the audience member 118, and monitors the monetary amounts to be paid, by the advertisers 110.1-110.m, to the audience member 118 for the value of the advertisements consumed by the audience member 118. The instructions provided by the ad matching entity 112 can include any suitable information that the settlement system 114 can use to authenticate the validity of the accounts associated with the audience member, the content owners, and/or the advertisers. It is noted, however, that the settlement system 114 does not gain access to any information from which any private or sensitive audience member information can be derived. It should be appreciated that each of the advertisers 110.1-110.m and each of the information content owners 116.1-116.n has an associated computer or computerized device communicably coupled to the network 102.

The presently disclosed system 100 for delivering and accessing information such as advertisements targeted to a user (an “audience member”) will be better understood with reference to the following illustrative example and FIGS. 1a-1b. In this example, the audience member 118 interacts with the computerized member device 104, such as a personal computer (PC), to obtain desired information content, which may include text, image, audio, and/or video information contained in a web page, a song, a movie, or any other suitable type of information content. The audience member 118 also interacts with the computerized member device 104 (the “PC 104”) to receive at least one advertisement (the “ad content”) for a product, a service, or any other suitable content relevant to his or her background and interests. As shown in FIG. 1a, the PC 104 is positioned within the system 100 between the audience member 118 and the network 102 to allow the PC 104, specifically, the member profile manager component 130, to observe all of the interactions 120 of the audience member 118 with the various entities connected to the network 102. Such audience member interactions 120 observed by the PC 104 can include the visiting of web pages, the on-line purchase of a product or service, the use of a web search engine, the execution of software applications, the sending of e-mail messages, etc. By observing such interactions 120, the PC 104 can obtain information relating to, e.g., the time the audience member 118 spent viewing the respective web pages, the frequency of web page visits, the types of products or services purchased, the specific web search terms used, the types of software applications executed, the nature of the e-mail messages, etc. Using this information, the member profile manager component 130 within the PC 104 can create a profile of the audience member, containing data indicative of his or her demonstrated interests. The member profile manager component 130 can also receive information submitted by the audience member 118, e.g., via a keyboard or any other suitable input device of the PC 104, relating to certain attributes of the audience member 118 such as the location where he or she lives, and/or his or her age group, educational background, profession, income level, marital status, hobbies and specific interests, etc. In this way, the audience member 118 can explicitly specify and locally manage his or her own profile (e.g., by viewing, editing, adding, and/or deleting profile data, as desired) to attract ad content that matches his or her background and interests, to avoid undesirable ad content, and to assure that sensitive or strictly private information is not included in the member profile data. Via the computerized member device 104, for example, the PC 104, the audience member profile is completely visible to and editable by the audience member, and under his/her complete and exclusive control.

In the event the audience member 118 wishes to receive targeted ad content and/or information content, he or she can cause or enable the audience member profile to be transmitted, via the PC 104, to the ad matching entity 112 over a secure network connection using, for example, a data encryption technique and/or any other suitable data security technique. For example, the audience member 118 may be motivated to receive targeted ad content for the purpose of receiving relevant, useful advertisements, and/or to receive possible payment toward past or future consumption of desired information content as a result of consuming the ad content. It is noted that one or more of the information content owners 116.1-116.n may directly offer potentially desirable information content to the audience member 118, thereby effectively acting as an advertiser of the offered content.

As discussed above, the ad matching entity 112 is a trusted third party operative to match ad content provided by one or more of the advertisers 110.1-110.m with the audience member 118, based at least in part upon the data contained in the audience member profile. As a trusted third party, the ad matching entity 112 facilitates the interactions between the audience member 118 and the advertisers 110.1-110.m, both of which trust the ad matching entity 112. Within the system 100, no mechanism is provided for any entity other than the trusted ad matching entity 112 to gain access to or query the data contained in the audience member profile. The ad matching entity 112 temporarily stores the audience member profile in a data storage until the ad matching procedure is completed. For example, at least one of the advertisers 110.1-110.m can provide the ad matching entity 112 with at least one target profile, and the ad matching entity 112 can determine whether or not the audience member profile matches the advertiser's target profile, which can contain data indicative of the relevance of an advertised product or service to the target consumer. If the ad matching entity 112 determines that the audience member profile matches the advertiser's target profile, then the ad matching entity 112 transmits appropriate ad content, targeted to the audience member 118, to the PC 104, thereby completing the ad matching procedure. Otherwise, the ad matching entity 112 can optionally transmit generic ad content to the PC 104. In an alternative embodiment, the ad matching entity 112 can transmit a reference to the targeted ad content (e.g., a hyperlink or a URL) that the audience member 118 can use to receive the ad content over the network 102. The ad matching entity 112 then permanently deletes the audience member profile from its data storage, leaving no record or copies of the profile data, and no indication of the identity of the audience member 118 to whom the ad content was directed.

Upon receipt of the targeted ad content, the PC 104 stores the ad content (or the reference to the ad content) in the content storage component 132. As discussed above, the PC 104 also stores, in the content storage component 132, any desired information content offered by one or more of the information content owners 116.1-116.n and downloaded by the audience member 118. The audience member 118 then consumes (i.e., views and/or listens to) the stored ad content and information content in real-time, or at some later time, using the content viewer component 134 included in the PC 104. Advantageously, the content viewer component 134 is operative to allow the audience member 118 to consume the targeted ad content in an out-of-line fashion that is independent of the consumption of the desired information content. In one embodiment, the computerized member devices 104, 106, 108 are coupled to the communications network 102 and/or any other suitable network to allow the stored ad content to be consumed by the audience member 118 using the PC 104, and to allow the stored information content (e.g., one or more web pages, songs, and/or movies) to be consumed at the same time or some other time, by the same individual or some other individual, using one of the other computerized devices 106, 108. The content viewer component 134 can also be configured to prevent consumption of any ad content or information content that is no longer valid or allowed for user consumption based upon, e.g., the passage of a specified length of time and/or the number of times the content has already been consumed.

Moreover, the content viewer component 134 is operative to monitor how the audience member 118 interacts with the stored ad content and information content, and the member profile manager component 130 is operative to update automatically the audience member profile based at least in part upon the monitored interactions. Further, using information obtained from the monitored interactions by the content viewer component 134, the PC 104 can generate and provide performance-based feedback to the ad matching entity 112 relating to, e.g., whether the targeted ad content was consumed by the audience member 118 completely or partially, the number of times the ad content was consumed by the audience member 118, whether or not the audience member 118 acted (e.g., made a purchase) in response to his or her consumption of the ad content, whether or not the ad content was saved by the audience member 118, whether desired information content associated with the ad content was consumed by the audience member 118 completely or partially, the number of times the desired information content was consumed by the audience member 118, the order in which targeted ad content and the desired information content were consumed by the audience member 118, etc. Based upon the performance-based feedback provided by the PC 104, the ad matching entity 112 can make appropriate adjustments to its ad matching procedure, and can obtain a measure of the performance of the targeted ad content that can, if desired, influence the cost of the ad content to the advertiser. Further, the ad matching entity 112 can provide information based upon the performance-based feedback to one or more of the information content owners 116.1-116.n, thereby allowing the information content owners 116.1-116.n to obtain a measure of the performance of their information content.

In addition, while the audience member 118 consumes the ad content, he or she can interact with the content viewer component 134 to judge the relevance of the ad content to his or her background and interests, thereby determining the value of specific ad content, e.g., as a possible source of payment for any desired information content. Such payment for desired information content is herein referred to as advertiser-supported payment. It is noted that any payment for desired information content that is not advertiser-supported is herein referred to as user-supported or member-supported payment. For example, via observable audience member interactions with the content viewer component 134, the behavior of the audience member 118 can be observed to provide an indication of whether or not specific ad content is being consumed based upon its content, to provide an indication of whether or not specific ad content is being consumed based upon its value, to determine whether a remaining portion of uninteresting ad content has been skipped, to provide an indication of an order or priority of ad content consumption, to determine whether a predetermined action (e.g., the making of a purchase) has been performed in response to the ad content, to determine whether the relevance of specific ad content has been affirmed in order to stimulate the transmission of additional ad content having similar relevance to the audience member 118, etc. For example, the PC 104 can transmit, to the ad matching entity 112, information corresponding to the audience member interactions with the content viewer component 134 as part of the performance-based feedback, which can, if desired by the advertiser, influence the value credited to the audience member 118 for viewing the ad content. Based upon the performance-based feedback, the ad matching entity 112 can determine, in accordance with at least one rule, a monetary amount to be credited to the audience member's account by the settlement system 114 for the value associated with his or her consumption of the ad content. The ad matching entity 112 can also determine, according to at least one rule, a monetary amount to be charged to or debited from the advertiser's account for the cost of the ad content by the settlement system 114.

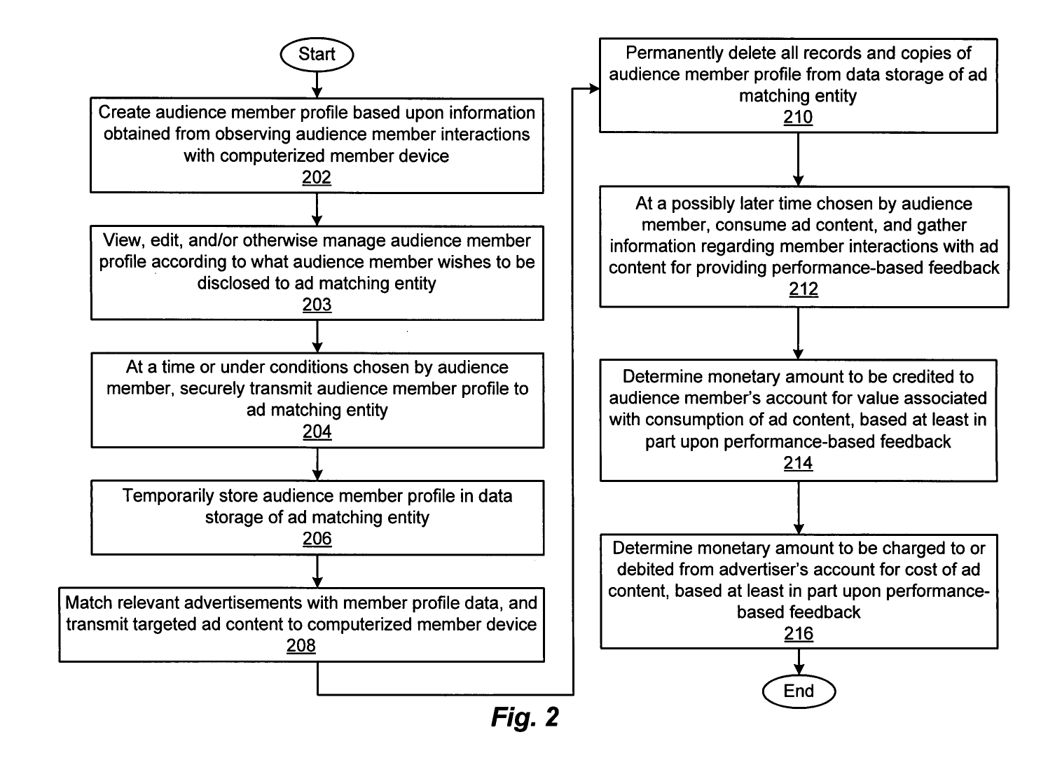

A method of delivering and accessing targeted advertisements using the presently disclosed system 100 is described below with reference to FIGS. 1a-1b and 2. As depicted in step 202, at least one of the computerized member devices 104, 106, 108 communicably coupled to the network 102 creates, using its associated member profile manager component 130, an audience member profile based upon information obtained from observing an audience member's interactions with the device, and/or specific information submitted to the device by the audience member. Via the member profile manager component 130 associated with the computerized member device, the audience member can view, edit, and/or otherwise manage his or her own profile according to what he or she wishes to be disclosed to the ad matching entity 112 for the purpose of receiving relevant ad content and/or information content, as depicted in step 203. Next, as depicted in step 204, at such time or under such conditions when the audience member voluntarily chooses to disclose, outside of the computerized member device, the data contained in the audience member profile, the audience member profile is securely transmitted by the device over the network 102 to the ad matching entity 112, which is a trusted third party entity. The ad matching entity 112 then temporarily stores the audience member profile in a data storage, as depicted in step 206. Next, the ad matching entity 112 matches relevant advertisements (the “ad content”) with the data contained in the audience member profile, and transmits the ad content, targeted to the audience member, to the computerized member device for storage in its associated content storage component 132, as depicted in step 208. Next, the ad matching entity 112 permanently deletes all records and copies of the audience member profile from its data storage, as depicted in step 210. As depicted in step 212, at a possibly later time chosen by the audience member, the audience member consumes (i.e., views and/or listens to) the stored ad content using the content viewer component 134 associated with the computerized member device. Further, while the audience member consumes the ad content, the content viewer component 134 gathers information relating to how the audience member 118 interacts with the ad content for subsequent use in providing performance-based feedback to the ad matching entity 112, as depicted in step 212. Based upon how the ad content was consumed by the audience member, for example, whether the ad content was skipped over, partially consumed, or completely consumed by the audience member, the ad matching entity 112 determines the monetary amount that is to be credited to the audience member's account by the settlement system 114 for the value associated with his or her consumption of the ad content, as depicted in step 214. The ad matching entity 112 then determines, based upon how the ad content was consumed by the audience member, a corresponding monetary amount that is to be charged to or debited from the advertiser's account by the settlement system 114 for the cost of the ad content, as depicted in step 216.

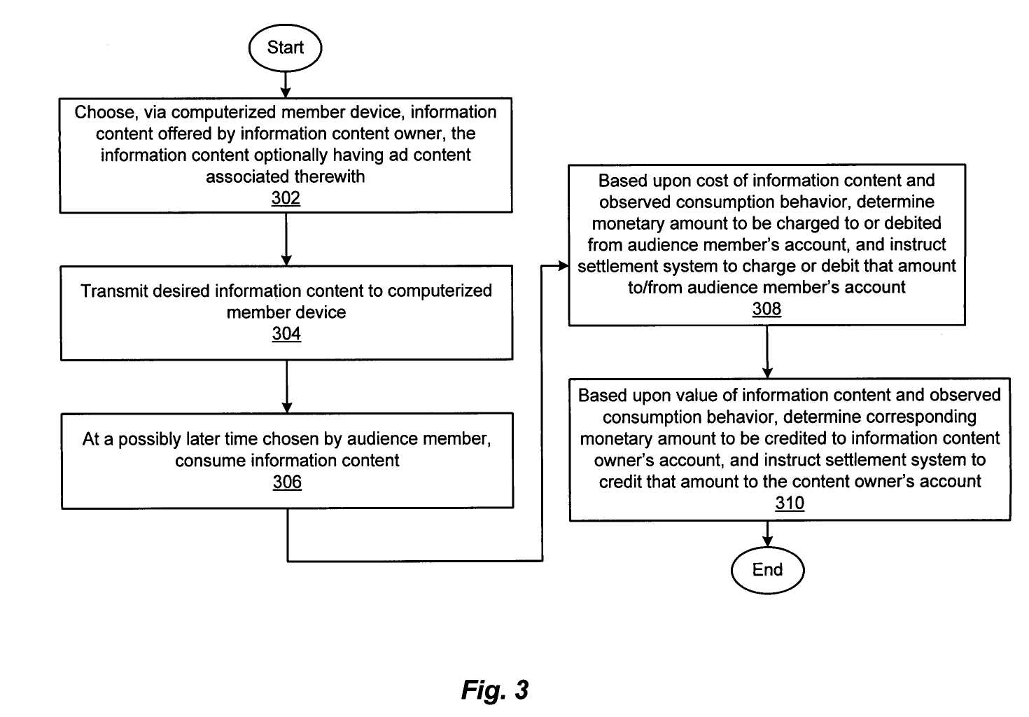

A method of consuming desired information content using the presently disclosed system 100 is described below with reference to FIGS. 1a-1b and 3. As depicted in step 302, an audience member chooses, via one of the computerized member devices 104, 106, 108, information content offered by one of the information content owners 116.1-116.n for subsequent consumption. As discussed above, the desired information content can optionally have ad content associated therewith. Next, the chosen information content is transmitted over the network 102 to one or more of the computerized member devices 104, 106, 108, which optionally stores the information content in its associated content storage component 132, as depicted in step 304. For example, the information content may be transmitted to the audience member for immediate consumption in real-time, as is typical in a broadcast medium (e.g., cable TV), or in a streamed or downloaded delivery to one of the computerized member devices 104, 106, 108. As depicted in step 306, at a possibly later time chosen by the audience member, the audience member consumes (i.e., views and/or listens to) the stored information content using the content viewer component 134 associated with the computerized member device. For example, the audience member can consume the desired information content independently of the consumption of the associated ad content. Next, the ad matching entity 112 determines, based upon the cost of the information content chosen and the observed consumption behavior of the audience member, the monetary amount to be charged to or debited from the audience member's account, and instructs the settlement system 114 to charge or debit that amount to/from the member's account, as depicted in step 308. The ad matching entity 112 then determines, based upon the value of the delivered information content and the observed consumption behavior of the audience member, a corresponding monetary amount to be credited to the information content owner's account, and instructs the settlement system 114 to credit that amount to the content owner's account, as depicted in step 310.

Having described the above illustrative embodiments, other alternative embodiments or variations may be made. For example, as discussed above, one or more of the information content owners may directly offer information content (e.g., a song or a movie) to the audience member, thereby effectively acting as an advertiser of the offered content. In one embodiment, the ad content provided by the ad matching entity can include an invitation to the audience member to consume potentially desirable information content, which may be targeted to the audience member based upon information contained in the audience member profile and/or the performance-based feedback. Further, the ad content may include a hyperlink or a uniform resource locator (URL) that the audience member can use to receive the targeted information content over the network. Moreover, the monetary amount charged, by the settlement system, to the audience member for consuming the targeted information content may be a function of how that information content was consumed (i.e., viewed and/or listened to) by the audience member, for example, whether the information content was consumed completely or partially, the number of times the information content was consumed, whether or not the information content was saved, etc.

In addition, it was described above that the computerized member device includes a content storage component operative to store ad content targeted to the audience member and any other information content targeted to or desired by the audience member, and to facilitate the audience member's consumption (i.e., viewing and/or listening) of the ad content and information content. In an alternative embodiment, the audience member may consume one or both of the ad content and the desired information content in real-time, thereby obviating the need to store one or both of the ad content and information content in the content storage component. For example, the audience member may view, in real-time, a television program via his or her a television-connected set top box (TV-STB), while targeted ad content is provided to and stored on his or her personal computer (PC) for subsequent consumption. Further, the audience member's consumption of the ad content stored on his or her PC may result in credits that the audience member can use to pay for his or her consumption of the television program. Alternatively, the audience member may consume both the targeted ad content and the desired information content (e.g., a television program) in real-time, without storing any of the ad content or information content in the content storage component. The audience member's consumption of the targeted ad content may also result in credits that he or she can use to pay for the consumption of the desired information content.

It should be appreciated that the ad matching entity in conjunction with the settlement system can implement any suitable compensation arrangement between the audience member, the advertisers, and the information content owners. Such a compensation arrangement may be based at least in part upon the audience member profile, the performance-based feedback, and/or any other suitable information or feedback relating to the audience member's consumption of ad content and/or desired information content. It should also be appreciated that each of the computerized member devices 104, 106, 108, and each of the computers or computerized devices associated with the advertisers 110.1-110.m, the ad matching entity 112, the settlement system 114, and the information content owners 116.1-116.n, can be embodied as a single computer system or as separate sub-systems, each including one or more processors, program code memory, an operating system, application software, and one or more network interfaces for transmitting and/or receiving data, ad content, and/or information content over the network 102 within the system 100 of FIG. 1a.

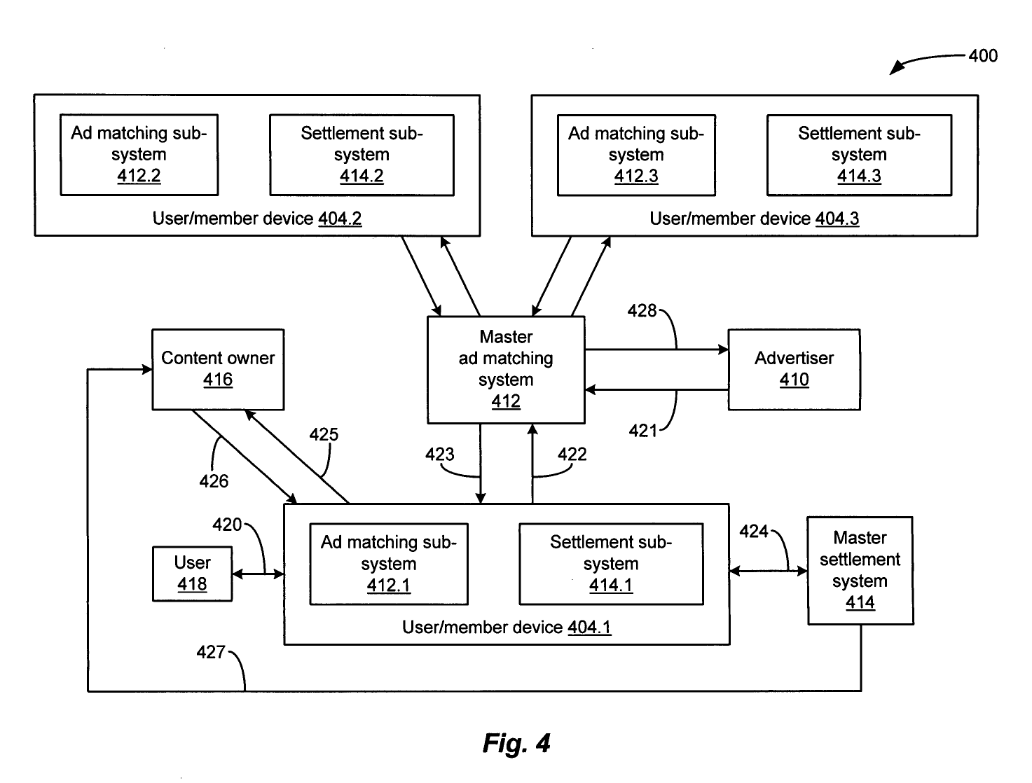

FIG. 4 depicts an illustrative alternative embodiment 400 of the system 100 of FIG. 1a, in which each of the ad matching entity and the settlement system is embodied as a master computer system and a plurality of separate computer sub-systems. In the illustrated embodiment, the system 400 includes a master ad matching system 412 and a plurality of ad matching sub-systems 412.1-412.3, a master settlement system 414 and a plurality of settlement sub-systems 414.1-414.3, an advertiser 410, a content owner 416, and a plurality of computerized user devices 404.1-404.3 and a representative user (the “audience member”) 418. As shown in FIG. 4, the ad matching sub-systems 412.1-412.3 are included in the computerized user devices 404.1-404.3, respectively, and the settlement sub-systems 414.1-414.3 are included in the computerized user devices 404.1-404.3, respectively, thereby allowing at least a portion of the functionality of the ad matching entity and the settlement system to be distributed among and performed locally at the respective user devices 404.1-404.3.

It should be understood that FIG. 4 depicts each of the ad matching sub-systems 412.1-412.3 and the settlement sub-systems 414.1-414.3 as being included in a respective one of the computerized user devices 404.1-404.3 for purposes of illustration, and that each of the sub-systems 412.1-412.3, 414.1-414.3 may alternatively be associated with but separate and remote from a respective user device. In one embodiment, the master ad matching system 412, the plurality of ad matching sub-systems 412.1-412.3, the master settlement system 414, the plurality of settlement sub-systems 414.1-414.3, the advertiser 410, the content owner 416, and the plurality of computerized user devices 404.1-404.3 comprise respective computerized devices communicably coupled via at least one network (not numbered) that includes a plurality of network pathways 421-428.

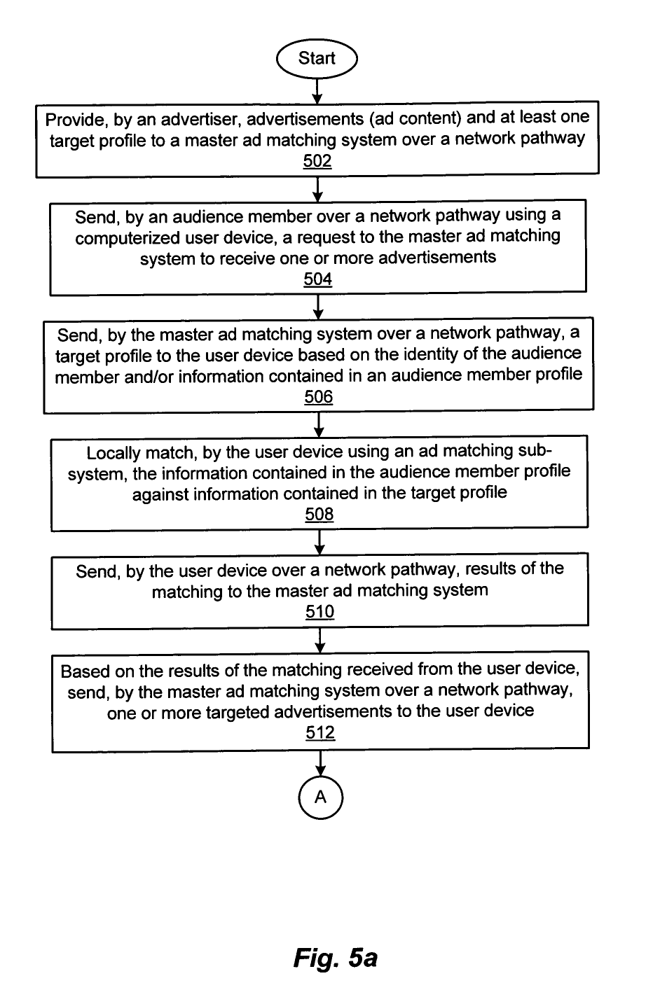

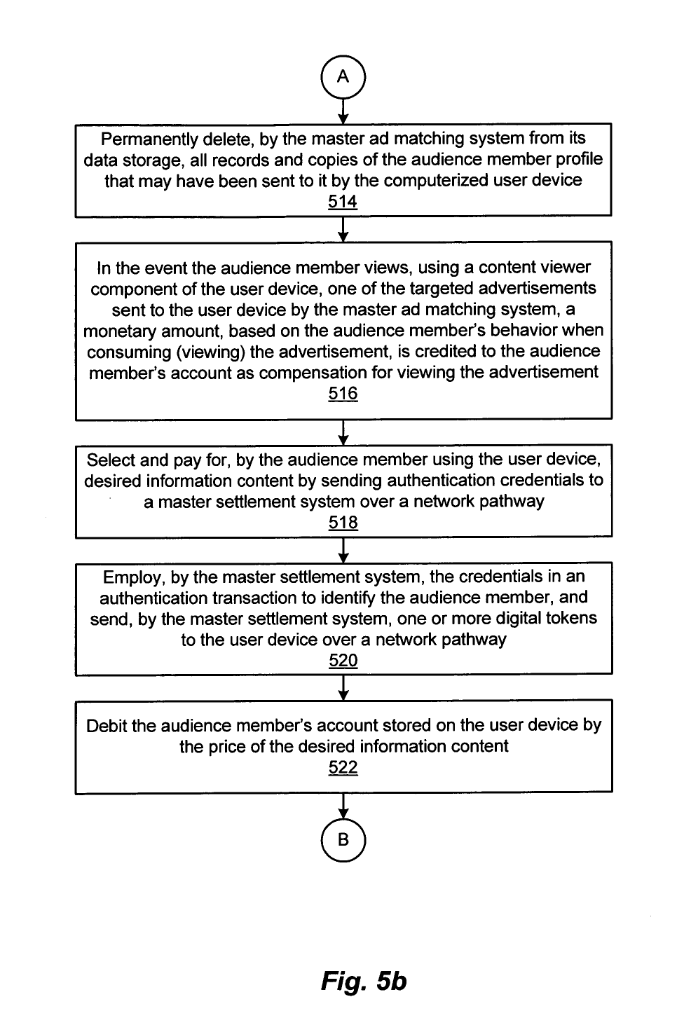

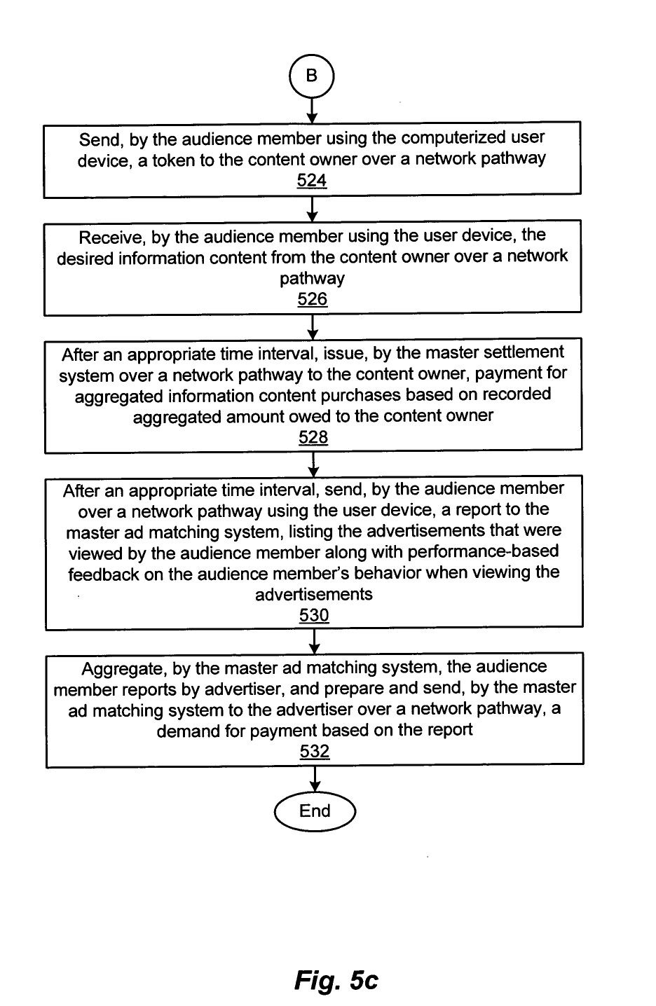

A method of consuming targeted advertisements and/or desired information content using a distributed, local ad matching and account settlement technique is described below with reference to FIGS. 4-5c. As depicted in step 502 (see FIG. 5a), the advertiser 410 provides advertisements (ad content) and at least one target profile to the master ad matching system 412 over the network pathway 421. In one embodiment, the advertiser 410 can also provide, to the master ad matching system 412 over the network pathway 421, an indication of one or more proposed monetary amounts to compensate an audience member for viewing targeted advertisements. For example, each of the proposed monetary amounts can be based on an estimate of the audience member's interest in and/or likelihood to purchase an advertised item, the audience member's profile and/or prior performance-based feedback relating to how a targeted advertisement and/or desired information content was previously consumed by that audience member, or any other suitable criteria.

Next, the audience member 418 sends, using the computerized user device 404.1 over the network pathway 422, a request to the master ad matching system 412 to receive one or more advertisements, as depicted in step 504. In one embodiment, the audience member 418 sends authentication credentials along with the request for advertisements to the master ad matching system 412, which can employ the credentials in an authentication transaction to identify the audience member 418. It is noted that when making such a request to receive advertisements, the audience member may send at least some of the information contained in the audience member profile to the master ad matching system 412, which may temporarily store the profile information. The master ad matching system 412 then sends, over the network pathway 423, a target profile to the user device 404.1 based on the identity of the audience member 418 and/or the information contained in the audience member profile, as depicted in step 506.

Next, the computerized user device 404.1 locally matches, using the ad matching sub-system 412.1, the information contained in the audience member profile against the information contained in the target profile, as depicted in step 508, and sends the results of the matching to the master ad matching system 412 over the network pathway 422, as depicted in step 510. Based on the results of the matching received from the user device 404.1, the master ad matching system 412 sends one or more targeted advertisements to the user device 404.1 over the network pathway 423, as depicted in step 512. In one embodiment, the master ad matching system 412 can also send, as an incentive for the audience member 418 to view a targeted advertisement, an indication of the monetary amount that the audience member 418 would receive in compensation for viewing that advertisement. For example, the indicated monetary amount may be based at least in part on a proposed monetary amount provided to the master ad matching system 412 by the advertiser 410. In the presently disclosed embodiment, the targeted advertisements are stored in the content storage component associated with the user device 404.1 for subsequent viewing by the audience member 418, using the content viewer component associated with the user device 404.1. The master ad matching system 412 then permanently deletes, from its data storage, all records and copies of the audience member profile that may have been sent to it by the user device 404.1, as depicted in step 514 (see FIG. 5b).

In the event the audience member 418 views, using the content viewer component of the computerized user device 404.1, one of the targeted advertisements sent to the device 404.1 by the master ad matching system 412, a monetary amount is subsequently credited to the audience member's account as compensation for viewing the advertisement, as depicted in step 516. For example, the monetary amount credited to the audience member's account may be based on performance-based feedback relating to how the targeted advertisement was consumed (viewed) by the audience member 418, a proposed monetary amount provided by the advertiser 410, and/or any other suitable criteria. In one embodiment, the audience member's account is stored on the computerized user device 404.1 in a cryptographically secure form, and can only be modified (credited or debited) by the settlement sub-system 414.1 associated with the user device 404.1. In an alternative embodiment, the audience member's account can be modified (credited or debited) by the master settlement system 414 over the network pathway 424. It is noted that, in one embodiment, the audience member's account is stored only on the computerized user device, and that no other interaction outside of the user device is required for the audience member to have spendable value in his or her account. For example, after an advertisement has been stored and viewed on the user device 404.1, compensation of the audience member 418 for viewing the advertisement can occur without any further interaction between the user device 404.1 and the master ad matching system 412 that supplied the targeted advertisement.

Next, using the computerized user device 404.1, the audience member 418 selects and pays for desired information content by sending authentication credentials to the master settlement system over the network pathway 424, as depicted in step 518. The master settlement system 414 then employs the credentials in an authentication transaction to identify the audience member 418, and sends one or more digital tokens to the user device 404.1 over the network pathway 424, as depicted in step 520. Each digital token generally comprises a specified series of bits, and represents the purchased rights to specified desired information content. Next, the audience member's account stored on the user device 404.1 is debited by the price of the desired information content, which is set by the content owner 416, as depicted in step 522. In one embodiment, the audience member's account is debited by the settlement sub-system 414.1 associated with the user device 404.1. In an alternative embodiment, the audience member's account is debited over the network pathway 424 by the master settlement system 414, which can also maintain one or more records of aggregated amounts owed to the content owner(s) or the content provider(s). Via the interaction between the user device 404.1, the settlement sub-system 414.1, and/or the master settlement system 414, the integrity of the audience member's account on the user device is maintained. It is noted that modifications (crediting or debiting) of the audience member's account can occur without any interaction or messaging involving the master ad matching system 412 or the advertiser 410. Using the user device 404.1, the audience member 418 then sends a token to the content owner 416 over the network pathway 425, as depicted in step 524 (see FIG. 5c), and receives the desired information content from the content owner 416 over the network pathway 426, as depicted in step 526.

After an appropriate time interval, the master settlement system 414 issues, to the content owner 416 over the network pathway 427, payment for aggregated information content purchases based on the recorded aggregated amount owed to the content owner 416, as depicted in step 528. Next, after an appropriate time interval, the audience member 418 sends, using the computerized user device 404.1 over the network pathway 422, a report to the master ad matching system 412, listing the advertisements that were viewed by the audience member 418 along with the performance-based feedback on the audience member's behavior when viewing the advertisements, as depicted in step 530. The master ad matching system 412 subsequently employs this report from the user device 404.1 when billing the advertiser 410. It is noted that the sending of this report by the user device 404.1 to the master ad matching system 412 for use in billing the advertiser(s) is not a requirement for the audience member 418 to earn additional credit for viewing advertisements, or to apply any earned credits to purchase desired information content. The master ad matching system 412 then aggregates the audience member reports by advertiser, and prepares and sends a demand for payment based on the report to the advertiser 410 over the network pathway 428, as depicted in step 532.

It will be appreciated by those of ordinary skill in the art that modifications to and variations of the above-described profile based advertising method for out-of-line advertising delivery may be made without departing from the inventive concepts disclosed herein. Accordingly, the invention should not be viewed as limited except as by the scope and spirit of the appended claims.

What is claimed is:

1. A system for providing targeted content to a user, comprising:
at least one network;
a plurality of computerized user devices communicably coupled to said at least one network, each of said plurality of computerized user devices including a user profile manager component, each of said plurality of computerized user devices being operative to perform, in response to user interaction with the respective computerized user device, at least one specified action; and
at least one computerized trusted device communicably coupled to said at least one network, the computerized trusted device including a plurality of separate sub-systems, each of said plurality of separate sub-systems of the computerized trusted device being associated with one of said plurality of computerized user devices,
wherein said user profile manager component within each of said plurality of computerized user devices is operative to generate, in response to said at least one specified action performed by the respective computerized user device, data corresponding to said at least one specified action, and to generate a user profile containing at least some of the generated data,
wherein each of said plurality of separate sub-systems of the computerized trusted device is operative to match content with said user based at least in part upon the data contained in said user profile generated by said user profile manager component within the computerized user device associated with the respective sub-system, and
wherein the computerized trusted device is operative to transmit, over said at least one network, the matched content to the computerized user device associated with the respective sub-system.

2. The system of claim 1 wherein the computerized trusted device has an associated data storage, wherein each of said plurality of computerized user devices is operative to transmit, in response to at least one user input, said user profile over said at least one network to the computerized trusted device, and wherein the computerized trusted device is further operative to store said user profile in said associated data storage, and to delete said user profile from said associated data storage subsequent to transmitting the matched content to the computerized user device.

3. The system of claim 1 wherein each of said plurality of computerized user devices is operative to transmit, in response to at least one user input, said user profile over a secure network connection to the computerized trusted device.

4. The system of claim 1 wherein each of said plurality of computerized user devices includes at least one user input device, and wherein each of said plurality of computerized user devices is further operative to perform, in response to said user interaction with the respective computerized user device, at least one specified action including receiving, from said user via said at least one user input device, information pertaining to said user.

5. The system of claim 1 wherein each of said plurality of computerized user devices includes at least one user input device and at least one computer display device, and wherein each of said plurality of computerized user devices is configured to allow said user to view, via said at least one computer display device, said user profile, and to modify, via said at least one user input device, said user profile.

6. The system of claim 1 wherein each of said plurality of computerized user devices is further operative to perform, in response to said user interaction with the respective computerized user device, at least one specified action, said at least one specified action including one or more of providing information content to said user, ceasing to provide information content to said user, accessing at least one web page, performing at least one web search using at least one web search term, executing at least one software application, transmitting at least one e-mail message, and placing at least one telephone call.

7. The system of claim 1 wherein each of said plurality of computerized user devices further includes a content storage component operative to store the matched content.

8. The system of claim 1 wherein each of said plurality of separate sub-systems of the computerized trusted device is operative to match content with said user, the matched content including at least one advertisement.

9. The system of claim 8 wherein each of said plurality of separate sub-systems of the computerized trusted device is further operative to match said user profile against at least one target profile of at least one advertiser.

10. The system of claim 1 wherein each of said plurality of computerized user devices further includes a content viewer component operative to enable said user to consume the matched content.

11. The system of claim 10 wherein each of said plurality of computerized user devices is further operative to generate, in response to at least one specified action performed by said user while consuming the matched content, performance-based feedback relating to the matched content, and to transmit said performance-based feedback over said at least one network to the computerized trusted device.

12. The system of claim 11 wherein said at least one specified action performed by said user while consuming the matched content includes one or more of completely consuming the matched content, partially consuming the matched content, consuming the matched content multiple times, making a purchase, and saving at least a portion of the matched content.

13. The system of claim 12 wherein the matched content comprises at least one advertisement, and wherein said at least one specified action performed by said user while consuming the matched content includes one or more of completely consuming information content associated with said at least one advertisement, partially consuming said information content associated with said at least one advertisement, consuming said information content associated with said at least one advertisement multiple times, and consuming said at least one advertisement and said information content associated with said at least one advertisement in a predetermined order.

14. The system of claim 11 further including at least one settlement system, the settlement system being communicably coupled to said at least one network, wherein the matched content comprises at least one advertisement associated with at least one advertiser, and wherein the computerized trusted device is operative to generate, based at least in part upon said performance-based feedback, at least one instruction for implementing at least one monetary settlement involving one or more of said user and said at least one advertiser, and to transmit said at least one instruction to the settlement system for subsequent use in implementing said at least one monetary settlement.

15. The system of claim 11 further including at least one settlement system, the settlement system being communicably coupled to said at least one network, wherein the matched content comprises information content associated with at least one information content owner, and wherein the computerized trusted device is operative to generate, based at least in part upon said performance-based feedback, at least one instruction for implementing at least one monetary settlement involving one or more of said user and said at least one information content owner, and to transmit said at least one instruction to the settlement system for subsequent use in implementing said at least one monetary settlement.

16. The system of claim 1 wherein each of said plurality of computerized user devices comprises one or more of a personal computer (PC), a television-connected set top box (TV-STB), a personal video recorder (PVR), a Smartphone, a personal digital assistant (PDA), a home gateway device, and a media extender device.

17. The system of claim 1 wherein said at least one network comprises one or more of a private network and a public network.

18. The system of claim 17 wherein said private network comprises one or more of a wireless private network and a wired private network.

19. The system of claim 17 wherein said public network comprises one or more of a wireless public network and a wired public network.

20. The system of claim 17 wherein said private network comprises one or more of a local area network (LAN) and a wide area network (WAN).

21. The system of claim 17 wherein said public network comprises one or more of the Internet, a cable television (CATV) distribution network, a wide area telephone network, and a wide area data network.

22. A system for providing information content and associated advertisement content to a user, comprising:
at least one network;
at least one computerized user device communicably coupled to said at least one network, the computerized user device including a content storage component, and a content viewer component; and
at least one computerized content provider device communicably coupled to said at least one network, the computerized content provider device being operative to provide said information content and said associated advertisement content over said at least one network to the computerized user device,
wherein said content storage component is operative to store at least a portion of one or more of said information content and said associated advertisement content provided by the computerized content provider device, and
wherein said content viewer component is operative to allow said user to consume the advertisement content independently of said information content.

23. The system of claim 22 wherein said content viewer component is further operative to allow said user to consume said information content and the associated advertisement content at different times.

24. The system of claim 22 wherein said at least one computerized user device includes a plurality of computerized user devices, each of said plurality of computerized user devices including a respective content viewer component, and wherein a first one of said plurality of computerized user devices is operative to allow said user to consume the advertisement content, and wherein a second one of said plurality of computerized user devices is operative to allow said user to consume said information content.

25. A system for providing information content and advertisement content to a user, said information content being associated with at least one information content owner, said advertisement content being associated with at least one advertiser, comprising:
at least one network;
a plurality of computerized user devices communicably coupled to said at least one network, each of said plurality of computerized user devices including a content viewer component;
at least one computerized trusted device communicably coupled to said at least one network, the computerized trusted device including a plurality of separate sub-systems, each of said plurality of separate sub-systems of the computerized trusted device being associated with one of said plurality of computerized user devices; and
at least one settlement system communicably coupled to said at least one network, the settlement system including a plurality of separate sub-systems, each of said plurality of separate sub-systems of the settlement system being associated with one of said plurality of computerized user devices,
wherein said content viewer component within each of said plurality of computerized user devices is operative to allow said user to consume said information content and said advertisement content,
wherein each of said plurality of computerized user devices is operative to generate, responsive to at least one specified action performed by said user while consuming one or more of said information content and said advertisement content, data corresponding to said at least one specified action, and to generate performance-based feedback containing at least some of the generated data, said performance-based feedback relating to one or more of said information content and said advertisement content,
wherein each of said plurality of separate sub-systems of the computerized trusted device is operative to generate, based at least in part upon said performance-based feedback generated by the computerized user device associated with the respective sub-system of the computerized trusted device, at least one instruction for implementing at least one monetary settlement for at least one consumption of one or more of said information content and said advertisement content by said user, and to provide said at least one instruction to the sub-system of the settlement system associated with the computerized user device that generated said performance-based feedback, and
wherein the sub-system of the settlement system associated with the computerized user device that generated said performance-based feedback is operative to implement, based upon said at least one instruction, said at least one monetary settlement.

26. The system of claim 25 wherein said at least one specified action performed by said user while consuming one or more of said information content and said advertisement content includes one or more of completely consuming one or more of said information content and said advertisement content, partially consuming one or more of said information content and said advertisement content, consuming one or more of said information content and said advertisement content multiple times, and saving, in said content storage component, at least a portion of one or more of said information content and said advertisement content after consuming one or more of said information content and said advertisement content.

27. The system of claim 25 wherein the sub-system of the computerized trusted device associated with the computerized user device that generated said performance-based feedback is further operative to determine at least one monetary amount to be credited to an account of said user for a value of said advertisement content consumed by said user, based at least in part upon said performance-based feedback.

28. The system of claim 25 wherein the sub-system of the computerized trusted device associated with the computerized user device that generated said performance-based feedback is further operative to determine at least one monetary amount to be charged to an account of said at least one advertiser for a value of said advertisement content consumed by said user, based at least in part upon said performance-based feedback.

29. The system of claim 25 wherein the sub-system of the computerized trusted device associated with the computerized user device that generated said performance-based feedback is further operative to determine at least one monetary amount to be credited to an account of said at least one information content owner for a value of said information content consumed by said user, based at least in part upon said performance-based feedback.

30. The system of claim 25 wherein the sub-system of the settlement system associated with the computerized user device that generated said performance-based feedback is further operative to determine at least one monetary amount to be charged to an account of said user for a value of said information content consumed by said user, based at least in part upon said performance-based feedback.

31. The system of claim 25 wherein the computerized user device that generated said performance-based feedback is further operative to transmit said performance-based feedback over said at least one network to the computerized trusted device.

32. A method of providing targeted content to a user, comprising the steps of:
performing, by at least one of a plurality of computerized user devices in response to user interaction with the respective computerized user device, at least one specified action, each of said plurality of computerized user devices being communicably coupled to at least one network, each of said plurality of computerized user devices including a user profile manager component;
generating, by said user profile manager component within the respective computerized user device that performed said at least one specified action in response to said at least one specified action, data corresponding to said at least one specified action;
generating, by said user profile manager component within the respective computerized user device that performed said at least one specified action, a user profile containing at least some of the generated data;
matching, by one of a plurality of sub-systems of a computerized trusted device, content with said user based at least in part upon the data contained in said user profile, said one of said plurality of sub-systems being associated with the respective computerized user device that performed said at least one specified action; and
transmitting, by the computerized trusted device over said at least one network, the matched content to the computerized user device associated with the respective sub-system.

33. The method of claim 32 wherein the matched content includes at least one advertisement, and wherein said method further includes receiving, by the computerized user device associated with the respective sub-system, information content from at least one computerized information content provider device, and determining, via said user interaction with the computerized user device associated with the respective sub-system, a value of said at least one advertisement as a source of payment for the matched content.

34. The method of claim 32 further including transmitting, by the computerized user device that performed said at least one specified action in response to at least one user input, said user profile over said at least one network to the computerized trusted device.

35. A method of providing information content and associated advertisement content to a user, comprising the steps of:
providing, by at least one computerized content provider device, said information content and said associated advertisement content over at least one network to at least one computerized user device, each of said computerized content provider device and said computerized user device being communicably coupled to said at least one network, said computerized user device including a content storage component, and a content viewer component;
storing, by said content storage component, at least a portion of one or more of said information content and said associated advertisement content provided by said computerized content provider device; and
allowing, by said content viewer component, said user to consume the advertisement content independently of said information content.

36. A method of providing information content and advertisement content to a user, said information content being associated with at least one information content owner, said advertisement content being associated with at least one advertiser, said method comprising the steps of:
consuming, by said user via one of a plurality of computerized user devices, one or more of said information content and said advertisement content, said plurality of computerized user devices being communicably coupled to at least one network;
generating, by said one of said plurality of computerized user devices in response to at least one specified action performed by said user while consuming one or more of said information content and said advertisement content, data corresponding to said at least one specified action;
generating, by said one of said plurality of computerized user devices, performance-based feedback containing at least some of the generated data, said performance-based feedback relating to one or more of said information content and said advertisement content;
generating, by one of a plurality of sub-systems of a computerized trusted device based at least in part upon said performance-based feedback, at least one instruction for implementing at least one monetary settlement for each consumption of said information content and said advertisement content by said user, said one of said plurality of sub-systems of said computerized trusted device being associated with the computerized user device that generated said performance-based feedback, said computerized trusted device being communicably coupled to said at least one network;
providing, by said one of said plurality of sub-systems of said computerized trusted device associated with the computerized user device that generated said performance-based feedback, said at least one instruction to one of a plurality of sub-systems of a settlement system, said one of said plurality of sub-systems of said settlement system being associated with the computerized user device that generated said performance-based feedback, said settlement system being communicably coupled to said network; and
implementing, by said one of said plurality of sub-systems of said settlement system associated with the computerized user device that generated said performance-based feedback based upon said at least one instruction, said at least one monetary settlement.

37. The method of claim 36 further including transmitting, by the computerized user device that generated said performance-based feedback, said performance-based feedback over said at least one network to the computerized trusted device.
